(19) United States
(12) Patent Application Publication
(10) Pub. No.: US 2026/0204653 A1
(43) Pub. Date: Jul. 16, 2026

(54) SECONDARY BATTERY AND ELECTRONIC APPARATUS

(71) Applicant: Ningde Amperex Technology Limited, Ningde (CN)

(72) Inventor: Heng GAO, Ningde (CN)

(73) Assignee: Ningde Amperex Technology Limited, Ningde (CN)

(21) Appl. No.: 19/444,896

(22) Filed: Jan. 9, 2026

(30) Foreign Application Priority Data
Jan. 10, 2025 (CN) 202510044746.0

(51) Int. Cl. H01M 10/0587; H01M 4/02; H01M 4/587

(52) U.S. Cl. CPC H01M 10/0587; H01M 4/587; H01M 2004/021; H01M 2004/027; H01M 2220/30

(57) ABSTRACT

A secondary battery includes an electrode assembly, including a positive electrode plate and a negative electrode plate. A positive electrode active material layer is disposed on both a first surface and a second surface of a positive electrode current collector. A first negative electrode active material layer is disposed on both a third surface and a fourth surface of a negative electrode current collector. The positive electrode active material layer includes a first region. The first negative electrode active material layer includes a second region. The first region is located on an outer side of the second region in a corner region of the electrode assembly. A second negative electrode active material layer is disposed on the second region, and a gram capacity of the second negative electrode active material layer is greater than a gram capacity of the first negative electrode active material layer.

### CROSS REFERENCE TO RELATED APPLICATION

This application claims priority to the Chinese Patent Application Ser. No. 202510044746.0, filed on Jan. 10, 2025, the content of which is incorporated herein by reference in its entirety.

### TECHNICAL FIELD

This application relates to the field of energy storage technology, in particular to a secondary battery and an electronic apparatus including such secondary battery.

### BACKGROUND

With the popularity of consumer electronic products such as laptops, mobile phones, handheld game consoles, tablets, mobile power sources, and drones, the requirements on the safety performance and cycle life of secondary batteries are becoming increasingly stringent.

A secondary battery typically includes a housing and an electrode assembly disposed within the housing. In the related art, when the electrode assembly is a wound structure, the electrode assembly is prone to lithium precipitation in a corner region, reducing the safety and cycle life of the secondary battery.

### SUMMARY

In view of this, it is necessary to provide a secondary battery that can alleviate lithium precipitation in a corner region of an electrode assembly.

In addition, it is also necessary to provide an electronic apparatus including such secondary battery.

A first aspect of this application provides a secondary battery, including an electrode assembly. The electrode assembly includes a positive electrode plate, a separator, and a negative electrode plate, where the positive electrode plate, the separator, and the negative electrode plate are sequentially stacked and wound. The positive electrode plate includes a positive electrode current collector and positive electrode active material layers. The positive electrode current collector includes a first surface facing toward a winding central axis and a second surface facing away from the first surface, and the positive electrode active material layers are disposed on the first surface and the second surface, respectively. The negative electrode plate includes a negative electrode current collector and first negative electrode active material layers. The negative electrode current collector includes a third surface facing toward the winding central axis and a fourth surface facing away from the third surface, and the first negative electrode active material layers are disposed on the third surface and the fourth surface, respectively. The electrode assembly includes a corner region. The positive electrode active material layer includes a first region, where the first region is disposed on the first surface and located in the corner region. The first negative electrode active material layer includes a second region, where the second region is disposed on the fourth surface and located in the corner region. The first region is located on an outer side of the second region facing away from the winding central axis and is disposed opposite to the second region. The negative electrode plate further includes a second negative electrode active material layer disposed on the second region. A gram capacity of the second negative electrode active material layer is greater than a gram capacity of the first negative electrode active material layer.

In this application, the negative electrode plate further includes a second negative electrode active material layer disposed on the second region, and the second negative electrode active material layer has a higher gram capacity, which is conducive to increasing a capacity per unit area (that is, lithium intercalation capability) of the negative electrode active material opposite to the first region, that is, increasing a ratio of the capacity per unit area of the negative electrode active material layer to a capacity per unit area of the positive electrode active material layer opposite thereto in the corner region, namely a CB value, so that lithium ions deintercalated from the first region can be sufficiently intercalated into the negative electrode active material, thereby alleviating the problem of insufficient lithium intercalation space caused by smaller winding radius and specific surface area of the second region when the first region is located on the outer side of the second region, reducing the risk of lithium precipitation on the negative electrode plate in the corner region, and improving the safety and cycle life of the secondary battery. In addition, as compared to the technical solution in which the first negative electrode active material layer and the second negative electrode active material layer are alternately arranged on the fourth surface of the negative electrode current collector, this application is conducive to reducing the risk of increased thickness of the negative electrode plate caused by stacking of the first negative electrode active material layer and the second negative electrode active material layer at a junction, thereby facilitating reduction of volume swelling of the negative electrode plate during charging and discharging, and further prolonging the cycle life of the secondary battery.

Based on the first aspect, in some possible implementations, the electrode assembly further includes a flat region, and along a winding direction of the electrode assembly, the corner region is connected to the flat region. A length of an overlapping region of the second negative electrode active material layer and the flat region is 0 mm to 3 mm.

Based on the first aspect, in some possible implementations, the second negative electrode active material layer is disposed in only the second region. As compared to the technical solution in which the second negative electrode active material layer is applied onto the entire fourth surface, this application has a smaller impact on a positive electrode potential when the secondary battery is fully charged, thereby reducing safety risks.

Based on the first aspect, in some possible implementations, the second negative electrode active material layer is located on a surface of the second region facing toward the winding central axis. Therefore, lithium ions deintercalated from the first region are preferentially intercalated into the second region, especially when the second negative electrode active material includes a silicon material. This can reduce the risk of volume swelling of the silicon material due to intercalation of more lithium ions, further prolonging the cycle life of the secondary battery.

Based on the first aspect, in some possible implementations, the second negative electrode active material layer is located on a surface of the second region facing away from the winding central axis. As compared to the technical solution in which the second negative electrode active material layer is disposed on the surface of the second region facing toward the winding central axis, this application can increase the capacity per unit area of the negative electrode active material opposite to the first region under the premise that the negative electrode plate has the same thickness. In addition, after rolling, a part of the second negative electrode active material may protrude from the surface of the first negative electrode active material layer, so this part of the second negative electrode active material can increase the space for storing and circulating an electrolyte, which facilitates electrolyte infiltration, further reducing the risk of lithium precipitation on the negative electrode plate in the corner region, thereby further improving the safety and cycle life of the secondary battery.

Based on the first aspect, in some possible implementations, the ratio of the gram capacity of the second negative electrode active material layer to the gram capacity of the first negative electrode active material layer is 1.1 to 1.5. Therefore, on the one hand, the capacity per unit area of the negative electrode active material opposite to the first region can be increased, and on the other hand, the risk of high migration impedance of lithium ions inside the material caused by excessively small spacing between the second negative electrode active material layers can be reduced, so that it is easier for lithium ions to enter the second negative electrode active material, improving the dynamic performance of the secondary battery, thereby further reducing the risk of lithium precipitation on the negative electrode plate in the corner region.

Based on the first aspect, in some possible implementations, the ratio of the gram capacity of the second negative electrode active material layer to the gram capacity of the first negative electrode active material layer is 1.25 to 1.35, to further reduce the risk of lithium precipitation on the negative electrode plate in the corner region.

Based on the first aspect, in some possible implementations, the first negative electrode active material layer includes a first negative electrode active material, the second negative electrode active material layer includes a second negative electrode active material, the first negative electrode active material includes graphite, and the second negative electrode active material includes a silicon material. The provision of the above materials can increase the capacity per unit area of the negative electrode active material opposite to the first region, reduce the risk of lithium precipitation on the negative electrode plate in the corner region, and improve the safety and cycle life of the secondary battery.

Based on the first aspect, in some possible implementations, the silicon material includes one or more selected from the group consisting of silicon oxide, silicon-carbon compound, silicon alloy, and elemental silicon.

Based on the first aspect, in some possible implementations, the second negative electrode active material further includes graphite. By adjusting a content proportion of the silicon material and the graphite material in the second negative electrode active material, the gram capacity of the second negative electrode active material layer can be adjusted.

Based on the first aspect, in some possible implementations, a coating weight per unit area of the second negative electrode active material layer is 1.0 mg/cm² to 3.0 mg/cm². Therefore, on the one hand, a content of the second negative electrode active material can be increased, and on the other hand, the risk of blocking of ion channels caused by tight contact between particles of the second negative electrode active material can be reduced, improving the dynamic performance of the secondary battery, and also facilitating electrolyte infiltration, thereby further reducing the risk of lithium precipitation on the negative electrode plate in the corner region.

Based on the first aspect, in some possible implementations, the coating weight per unit area of the second negative electrode active material layer is 1.5 mg/cm² to 3.0 mg/cm², to further increase the content of the second negative electrode active material and further reduce the risk of lithium precipitation on the negative electrode plate in the corner region.

Based on the first aspect, in some possible implementations, the coating weight per unit area of the second negative electrode active material layer is 2.0 mg/cm² to 2.5 mg/cm².

Based on the first aspect, in some possible implementations, the positive electrode plate includes a first corner segment located in the corner region, where the first corner segment includes the first region. The negative electrode plate includes a second corner segment located in the corner region, where the second corner segment includes the second region. The first corner segment is located on an outer side of the second corner segment facing away from the winding central axis and is disposed opposite to the second corner segment. At least one of the first corner segment and the second corner segment includes multiple protrusions. The provision of the protrusions is conducive to reducing the risk of deterioration of electrolyte infiltration in the corner region caused by increased local volume swelling after the provision of the second negative electrode active material layer on the negative electrode plate (for example, provision of a second negative electrode active material layer including a silicon material), enhancing the ability of the corner region to store the electrolyte, thereby further prolonging the cycle life of the secondary battery.

Based on the first aspect, in some possible implementations, the first corner segment and the second corner segment are each provided with multiple protrusions. In this way, the ability of the corner region to store the electrolyte can be further improved, thereby further prolonging the cycle life of the secondary battery.

Based on the first aspect, in some possible implementations, an extension direction of the winding central axis is a first direction, a thickness direction of the electrode assembly is a second direction, and when viewed from a third direction, at least one of the multiple protrusions of the first corner segment at least partially overlaps with at least one of the multiple protrusions of the second corner segment, where the first direction, the second direction, and the third direction are perpendicular to each other. Therefore, while the ability of the corner region to store the electrolyte is improved, since the protrusions of the second corner segment can be at least partially embedded into a depression appearing on another side of the first corner segment, the risk of misalignment between the positive electrode plate and the negative electrode plate after winding can also be reduced, so that the first region and the second negative electrode active material layer can fully correspond to each other, achieving the effect of reducing the risk of lithium precipitation on the negative electrode plate in the corner region.

Based on the first aspect, in some possible implementations, the extension direction of the winding central axis is a first direction, the thickness direction of the electrode assembly is a second direction, and when viewed from the third direction, the multiple protrusions of the first corner segment do not overlap with the multiple protrusions of the second corner segment, where the first direction, the second direction, and the third direction are perpendicular to each other. This is conducive to further improving the ability of the corner region to store the electrolyte, thereby further prolonging the cycle life of the secondary battery.

Based on the first aspect, in some possible implementations, the negative electrode current collector includes a first conductive region and a second conductive region sequentially connected in the winding direction. The third surface located in the first conductive region is not provided with the first negative electrode active material layer, and the fourth surface located in the first conductive region is provided with the first negative electrode active material layer. Both the third surface and the fourth surface located in the second conductive region are provided with the first negative electrode active material layer. The second negative electrode active material layer is disposed on the second conductive region. Materials on two sides of a single-side coated region are uneven, which results in possible tension in the single-side coated region after winding. Therefore, as compared to the technical solution in which the second negative electrode active material layer is disposed on the first conductive region, disposing the second negative electrode active material layer on the second conductive region can reduce the risk of the first conductive region being more prone to wrinkling under tension, further prolonging the cycle life of the secondary battery.

Based on the first aspect, in some possible implementations, the negative electrode plate has N turns along the winding direction, where N is a positive integer greater than 3. The second negative electrode active material layer is located from the m-th turn to the n-th turn of the negative electrode plate along the winding direction, where m is the first turn where the second conductive region in the negative electrode plate is wound, and N/3≤n≤N/2. Since a first negative electrode active material layer closer to the winding central axis in the corner region has a higher risk of lithium precipitation, providing the second negative electrode active material layer from the m-th turn to the n-th turn of the negative electrode plate can reduce the risk of lithium precipitation in this part of the first negative electrode active material layer, further improving the safety and cycle life of the secondary battery. If n>N/2, an electrode plate located in an outer winding turn squeezes an electrode plate located in an inner winding turn, which is also likely to cause a reduced spacing between the electrode plates in the inner winding turn, so that the electrolyte is squeezed out and the electrolyte is less prone to infiltration, increasing the risk of lithium precipitation.

A second aspect of this application provides an electronic apparatus, including the above secondary battery. The electronic apparatus is supplied with power by the above secondary battery, and lithium precipitation in the corner region of the electrode assembly is alleviated, so the secondary battery has higher safety and cycle life.

### BRIEF DESCRIPTION OF DRAWINGS

FIG. 1 is a schematic cross-sectional view of a secondary battery according to an embodiment of this application.

FIG. 2 is an enlarged view of the secondary battery shown in FIG. 1 at block II.

FIG. 3 is an unfolded view of a positive electrode plate of the secondary battery shown in FIG. 1.

FIG. 4 is an unfolded view of a negative electrode plate of the secondary battery shown in FIG. 1 according to some embodiments.

FIG. 5 is an unfolded view of the negative electrode plate of the secondary battery shown in FIG. 1 according to some other embodiments.

FIG. 6 is an unfolded view of the negative electrode plate of the secondary battery shown in FIG. 1 according to still some other embodiments.

FIG. 7 is an enlarged view of the secondary battery shown in FIG. 1 according to some other embodiments.

FIG. 8 is an enlarged view of the secondary battery shown in FIG. 1 according to still some other embodiments.

FIG. 9 is an enlarged view of the secondary battery shown in FIG. 1 according to yet some other embodiments.

FIG. 10 is an enlarged view of the secondary battery shown in FIG. 1 according to further some embodiments.

FIG. 11 is a schematic overall structural diagram of an electronic apparatus according to an embodiment of this application.

### DESCRIPTION OF NUMERICAL SIGNS OF MAIN COMPONENTS

| | | | |
|---|---|---|---|
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | | |

[symbol]

indicates data missing or illegible when filed

This application is further described using the following specific embodiments in conjunction with the above drawings.

### DETAILED DESCRIPTION

The technical solutions in the embodiments of this application are clearly described in detail below. Apparently, the described embodiments are only some embodiments rather than all embodiments of this application. Unless otherwise defined, all technical and scientific terms used herein have the same meaning as commonly understood by those skilled in the technical field to which this application belongs. The terms used in the specification of this application are only for the purpose of describing specific embodiments and are not intended to limit this application.

The embodiments of this application are described in detail below. However, this application may be embodied in many different forms and should not be construed as being limited to the exemplary embodiments set forth herein. Rather, these exemplary embodiments are provided so that this application is thoroughly and detailedly understood by those skilled in the art.

In addition, for brevity and clarity, the sizes or thicknesses of various components and layers in the drawings may be exaggerated. Throughout the text, the same numerals refer to the same elements. As used herein, the term “and/or” includes any and all combinations of one or more of the associated listed items. In addition, it should be understood that when element A is referred to as being “connected” to element B, element A may be directly connected to element B, or intermediate element C may exist and element A and element B may be indirectly connected to each other.

Further, in the description of the embodiments of this application, “may” refers to “one or more embodiments of this application”.

The professional terms used herein are for the purpose of describing specific embodiments and are not intended to limit this application. As used herein, the singular forms are intended to include the plural forms as well, unless they are clearly indicated otherwise in the text. It should be further understood that the term “include”, when used in this specification, specifies the presence of stated features, numerical values, steps, operations, elements, and/or components, but does not exclude the presence or addition of one or more other features, numerical values, steps, operations, elements, components, and/or combinations thereof.

Space related terms, such as “upper” and the like, may be used herein for convenience of description to describe the relationship of one element or feature to another element(s) or feature(s) as illustrated in the figures. It should be understood that space related terms are intended to encompass different orientations of the device or apparatus in use or operation in addition to the orientation depicted in the figures. For example, if a device in the figures is turned over, elements described as “above” or “on” another element or feature would then be oriented “below” or “under” the other element or feature. Thus, the exemplary term “upper” may include both an upper and lower orientation. It should be understood that although the terms first, second, third, and the like may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below may be referred to a second element, component, region, layer, or section without departing from the instruction of the exemplary embodiments.

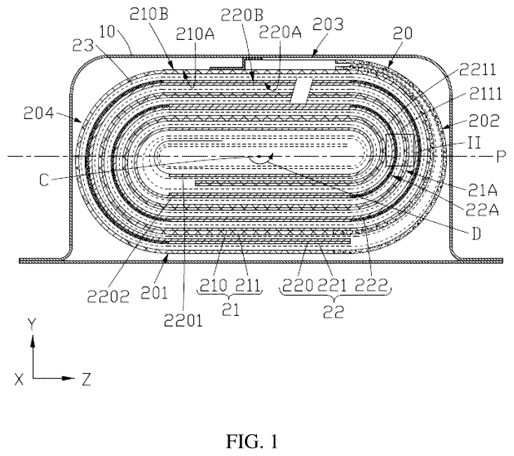

Referring to FIG. 1, an embodiment of this application provides a secondary battery 100, including a housing 10, an electrode assembly 20, and an electrolyte (not shown in the figure). The electrode assembly 20 and the electrolyte are located within the housing 10.

The electrode assembly 20 includes a positive electrode plate 21, a negative electrode plate 22, and a separator 23, where the separator 23 is disposed between the positive electrode plate 21 and the negative electrode plate 22. The positive electrode plate 21, the separator 23, and the negative electrode plate 22 are stacked and wound. The positive electrode plate 21 includes a positive electrode current collector 210 and positive electrode active material layers 211 disposed on the positive electrode current collector 210. The positive electrode current collector 210 includes a first surface 210A facing toward a winding central axis C and a second surface 210B facing away from the first surface 210A, and the positive electrode active material layers 211 are disposed on the first surface 210A and the second surface 210B, respectively. The negative electrode plate 22 includes a negative electrode current collector 220 and first negative electrode active material layers 221 disposed on the negative electrode current collector 220. The negative electrode current collector 220 includes a third surface 220A facing toward the winding central axis C and a fourth surface 220B facing away from the third surface 220A, and the first negative electrode active material layers 221 are disposed on the third surface 220A and the fourth surface 220B, respectively. In some embodiments, a negative electrode undercoat layer may alternatively be provided between the third surface 220A and the first negative electrode active material layer 221 or between the fourth surface 220B and the first negative electrode active material layer 221, where the negative electrode undercoat layer may be used to increase a bonding force between the negative electrode current collector 220 and the first negative electrode active material layer 221, reducing the risk of the first negative electrode active material layer 221 peeling off from the negative electrode current collector 220. A material of the negative electrode undercoat layer includes a binder and a conductive agent. The binder includes at least one of polyvinylidene fluoride (PVDF), sodium carboxymethyl cellulose (CMC), styrene-butadiene rubber (SBR), polyacrylic acid (PAA), polyvinyl alcohol (PVA), and polyimide (PI); and the conductive agent includes at least one of carbon black, carbon nanotube, and graphene. In some embodiments, a positive electrode undercoat layer may be provided between the positive electrode current collector 210 and the positive electrode active material layer 211, where the positive electrode undercoat layer may be used to increase a bonding force between the positive electrode current collector 210 and the positive electrode active material layer 211, reducing the risk of the positive electrode active material layer 211 peeling off from the positive electrode current collector 210. A material of the positive electrode undercoat layer includes a binder and a conductive agent. The binder includes at least one of polyvinylidene fluoride (PVDF), sodium carboxymethyl cellulose (CMC), styrene-butadiene rubber (SBR), polyacrylic acid (PAA), polyvinyl alcohol (PVA), and polyimide (PI); and the conductive agent includes at least one of carbon black, carbon nanotube, and graphene. In some embodiments, the positive electrode undercoat layer can also be used to improve the safety performance of secondary batteries, and the material of the positive electrode undercoat layer includes at least one of alumina, boehmite, silica, and metal oxides. A three-dimensional coordinate system is defined with a first direction X, a second direction Y, and a third direction Z that are perpendicular to each other. An extension direction of the winding central axis C is the first direction X, which is also a width direction of the positive electrode plate 21 or the negative electrode plate 22. A thickness direction of the electrode assembly 20 is the second direction Y The electrode assembly 20 may be divided into a first flat region 201, a first corner region 202, a second flat region 203, and a second corner region 204 sequentially connected in a winding direction D. The first flat region 201 and the second flat region 203 are disposed opposite to each other in the second direction Y, and the first corner region 202 and the second corner region 204 are disposed opposite to each other in the third direction Z. The corner region is a bent portion of the electrode assembly 20, and the corner region is a concept relative to the flat region. When viewed from the first direction X, the first corner region 202 and the second corner region 204 may be arc-shaped.

The positive electrode current collector 210 may be aluminum foil or nickel foil, and the negative electrode current collector 220 may be at least one of copper foil, nickel foil, or carbon-based current collector. The positive electrode active material layer 211 includes a positive electrode active material, and the positive electrode active material includes a compound (such as a lithiated intercalation compound) capable of reversibly intercalating and deintercalating metal active ions (such as lithium ions, sodium ions, and the like, where lithium ions are used as an example below). In some embodiments, the positive electrode active material may include a lithium transition metal composite oxide. The lithium transition metal composite oxide includes lithium and at least one element selected from cobalt, manganese, and nickel. In some embodiments, the positive electrode active material is selected from at least one of lithium cobalt oxide (LiCoO₂), lithium nickel cobalt manganese ternary material (NCM), lithium nickel cobalt aluminum ternary material (NCA), lithium manganate (LiMn₂O₄), lithium nickel manganate (LiNi_{0.5}Mn_{1.5}O₄), or lithium iron phosphate (LiFePO₄).

The first negative electrode active material layer 221 includes a first negative electrode active material, and the first negative electrode active material may be a negative electrode active material known in the art and capable of reversibly intercalating and deintercalating active ions. For example, the first negative electrode active material may include, but is not limited to, one or a combination of several of graphite, soft carbon, hard carbon, carbon fiber, mesocarbon microbeads, silicon material, tin-based material, lithium titanate, or other metals capable of forming alloys with lithium. The graphite may be selected from one or a combination of several of artificial graphite, natural graphite, and modified graphite; the silicon material may be selected from one or a combination of several of elemental silicon, silicon oxide compound, silicon-carbon composite, and silicon alloy; and the tin-based material may be selected from one or a combination of several of elemental tin, tin oxide compound, tin alloy, and the like.

The separator 23 includes at least one of polyethylene, polypropylene, polyvinylidene fluoride, polyethylene terephthalate, polyimide, or aramid. For example, the polyethylene includes at least one selected from high-density polyethylene, low-density polyethylene, or ultra-high molecular weight polyethylene.

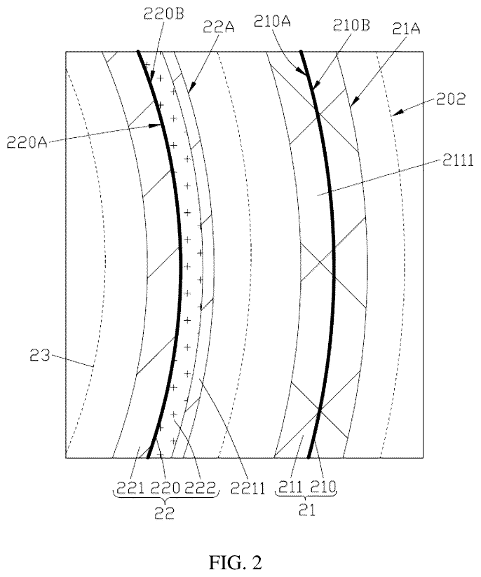

Referring to FIG. 1 and FIG. 2, the positive electrode active material layer 211 includes a first region 2111, where the first region 2111 is disposed on the first surface 210A and located in the corner region. The first negative electrode active material layer 221 includes a second region 2211, where the second region 2211 is disposed on the fourth surface 220B and located in the corner region. The first region 2111 is located on an outer side of the second region 2211 facing away from the winding central axis C and is disposed opposite to the second region 2211. In this embodiment of this application, an example in which the first region 2111 and the second region 2211 are both located in the first corner region 202 is used for description below. However, it can be understood that the first region 2111 and the second region 2211 may alternatively be located in the second corner region 204. In this embodiment of this application, the first region 2111 is located on the outer side of the second region 2211 facing away from the winding central axis C and is disposed opposite to the second region 2211, meaning that the first region 2111 and the second region 2211 are located on two adjacent turns of electrode plates of the electrode assembly 20, the first region 2111 is located on the outer layer of electrode plate of the two turns of electrode plates, the second region 2211 is located on the inner layer of electrode plate of the two turns of electrode plates, and the first region 2111 and the second region 2211 are disposed opposite to each other with the separator 23 located therebetween. Therefore, when viewed from the third direction Z, the first region 2111 and the second region 2211 at least partially overlap.

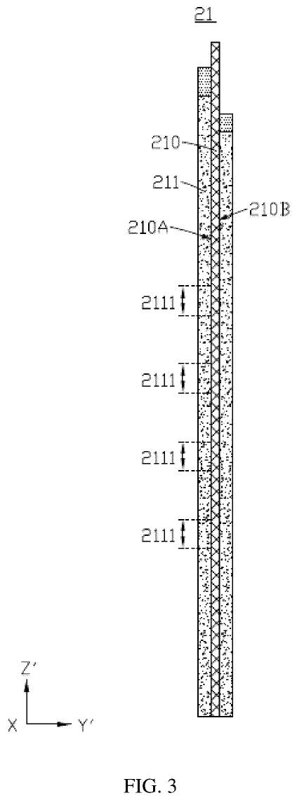

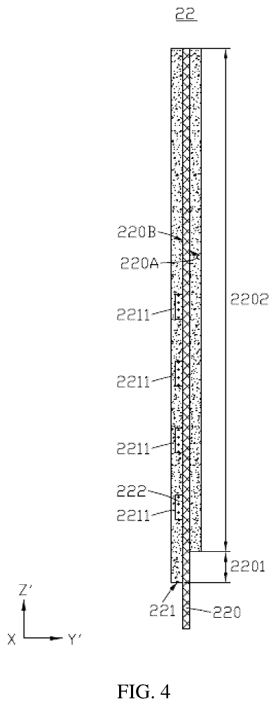

As shown in FIG. 2, there are multiple positive electrode active material layers 211 located in the first corner region 202, so the positive electrode active material layer 211 may include one first region 2111 or multiple first regions 2111, that is, at least two positive electrode active material layers 211 located in the first corner region 202 are provided with the first region 2111. As shown in FIG. 3 and FIG. 4, FIG. 3 is a schematic structural diagram of the positive electrode plate 21 in an unfolded state shown in FIG. 1, and FIG. 4 is a schematic structural diagram of the negative electrode plate 22 in an unfolded manner shown in FIG. 1. In FIG. 3 and FIG. 4, a three-dimensional coordinate system is established with the first direction X, a fourth direction Y′, and a fifth direction Z′, where the fourth direction Y′ is a thickness direction of the positive electrode plate 21 or the negative electrode plate 22, and the fifth direction Z′ is a length direction of the positive electrode plate 21 or the negative electrode plate 22. As shown in FIG. 3, when the positive electrode active material layer 211 includes multiple first regions 2111, the multiple first regions 2111 are spaced apart along the fifth direction Z′. As shown in FIG. 4, correspondingly, the first negative electrode active material layer 221 is also provided with multiple second regions 2211, and the multiple second regions 2211 are spaced apart along the fifth direction Z′. Referring to FIG. 2, the multiple second regions 2211 are disposed opposite to the multiple first regions 2111, respectively.

As shown in FIG. 1 to FIG. 4, the negative electrode plate 22 further includes a second negative electrode active material layer 222 disposed on the second region 2211. A gram capacity of the second negative electrode active material layer 222 is greater than a gram capacity of the first negative electrode active material layer 221, thereby increasing the capacity per unit area (that is, lithium intercalation capability) of the negative electrode active material opposite to the first region 2111. In some embodiments, when the first negative electrode active material includes graphite, the second negative electrode active material includes a silicon material. Further, the second negative electrode active material may further include a mixture of graphite and silicon material. By introducing two different negative electrode active materials into the second negative electrode active material layer 222, the second negative electrode active material layer 222 can combine the respective advantages of the two negative electrode active materials. Since graphite has certain flexibility, its combination with silicon material can alleviate the overall volume swelling of the second negative electrode active material layer 222, prolonging the cycle life of the secondary battery 100. In addition, graphite and silicon material jointly serve as the second negative electrode active material, and this can fully utilize the advantages of both to achieve better electrochemical performance. In some other embodiments, the implementation of this application is not limited to the negative electrode active materials listed above, and the types of the first negative electrode active material and the second negative electrode active material may be selected according to known negative electrode active materials and their gram capacities. In addition, in this application, the negative electrode active material can be modified to change a specific capacity value, thereby obtaining negative electrode active materials with different gram capacities.

In the related art, the first region is located on the outer side of the second region facing away from the winding central axis, the second region has smaller winding radius and specific surface area than the first region, so for lithium ions deintercalated from the first region, the second region cannot fully intercalate all these lithium ions due to insufficient lithium intercalation space, leading to lithium precipitation. The negative electrode plate 22 provided in this application further includes a second negative electrode active material layer 222 disposed on the second region 2211, and the second negative electrode active material layer 222 has a higher gram capacity, which is conducive to increasing the capacity per unit area of the negative electrode active material opposite to the first region 2111, that is, increasing a ratio of the capacity per unit area of the negative electrode active material layer to the capacity per unit area of the positive electrode active material layer 211 opposite thereto in the first corner region 202, namely a CB value, so that lithium ions deintercalated from the first region 2111 can be sufficiently intercalated into the negative electrode active material, thereby alleviating the problem of insufficient lithium intercalation space caused by the smaller winding radius and specific surface area of the second region 2211 when the first region 2111 is located on the outer side of the second region 2211, reducing the risk of lithium precipitation on the negative electrode plate 22 in the first corner region 202, and improving the safety and cycle life of the secondary battery 100. It can be understood that to further reduce the risk of lithium precipitation on the negative electrode plate 22, the gram capacity of the second negative electrode active material layer 222 in the second corner region 204 may also be increased in a similar manner.

In addition, as compared to the technical solution in which the first negative electrode active material layer 221 and the second negative electrode active material layer 222 are alternately arranged on the fourth surface 220B of the negative electrode current collector 220, this application is conducive to reducing the risk of increased thickness of the negative electrode plate 22 caused by stacking of the first negative electrode active material layer 221 and the second negative electrode active material layer 222 at the junction, thereby facilitating reduction of volume swelling of the negative electrode plate 22 during charging and discharging, thereby further prolonging the cycle life of the secondary battery 100. As compared to the technical solution in which the second negative electrode active material layer 222 is applied on the entire fourth surface 220B of the negative electrode current collector 220, this application has a smaller impact on the positive electrode potential when the secondary battery 100 is fully charged, thereby reducing safety risks.

In some embodiments, the ratio of the gram capacity of the second negative electrode active material layer 222 to the gram capacity of the first negative electrode active material layer 221 is 1.1 to 1.5. When the first negative electrode active material includes graphite and the second negative electrode active material includes a silicon material, the above ratio relationship of gram capacities is satisfied. In an example, the ratio of their gram capacities may be 1.1, 1.2, 1.3, 1.4, 1.5, or any value within a range defined by any two of these values. On the one hand, the capacity per unit area of the negative electrode active material opposite to the first region 2111 can be increased, and on the other hand, the risk of high migration impedance of lithium ions inside the material caused by excessively small spacing between the second negative electrode active material layers 222 can be reduced, thereby making it easier for lithium ions to enter the second negative electrode active material, and improving the dynamic performance of the secondary battery 100, thereby further reducing the risk of lithium precipitation on the negative electrode plate 22 in the first corner region 202.

In addition, a coating weight per unit area of the second negative electrode active material layer 222 may alternatively be set to 1.0 mg/cm² to 3.0 mg/cm². In an example, the coating weight per unit area of the second negative electrode active material layer 222 may be 1.0 mg/cm², 1.2 mg/cm², 1.5 mg/cm², 1.8 mg/cm², 2.0 mg/cm², 2.2 mg/cm², 2.5 mg/cm², 2.8 mg/cm², 3.0 mg/cm², or any value within a range defined by any two of these values. Therefore, on the one hand, the content of the second negative electrode active material can be increased, and on the other hand, the risk of blocking of ion channels caused by tight contact between particles of the second negative electrode active material can be reduced, improving the dynamic performance of the secondary battery 100, and also facilitating electrolyte infiltration, thereby further reducing the risk of lithium precipitation on the negative electrode plate 22 in the first corner region 202.

As shown in FIG. 1 and FIG. 2, in some embodiments, the second negative electrode active material layer 222 is located on a surface of the second region 2211 facing toward the winding central axis C. The second negative electrode active material layer 222 is located between the second region 2211 and the negative electrode current collector 220. Since the second negative electrode active material layer 222 is located on the surface of the second region 2211 facing toward the winding central axis C, during charging of the secondary battery 100, lithium ions deintercalated from the first region 2111 are preferentially intercalated into the second region 2211, especially when the first negative electrode active material includes graphite and the second negative electrode active material includes a silicon material. This can reduce the risk of volume swelling of the silicon material due to intercalation of more lithium ions, further prolonging the cycle life of the secondary battery 100. During manufacturing of the negative electrode plate 22, multiple mutually spaced second negative electrode active material layers 222 may be formed on the fourth surface 220B of the negative electrode current collector 220 by gravure coating, and then the first negative electrode active material layer 221 is disposed on the fourth surface 220B provided with the second negative electrode active material layers 222, where the first negative electrode active material layer 221 covers a surface of the second negative electrode active material layer 222 facing away from the winding central axis C and a side surface of the second negative electrode active material layer 222, and after rolling, a negative electrode plate 22 is obtained. In this case, the first negative electrode active material layer 221 located on the above surface of the second negative electrode active material layer 222 is the second region 2211. During coating, a slurry of the second negative electrode active material is in a liquid state and has fluidity, which can fully fill a gap between two adjacent second negative electrode active material layers 222, achieving uniform thickness of the negative electrode plate 22.

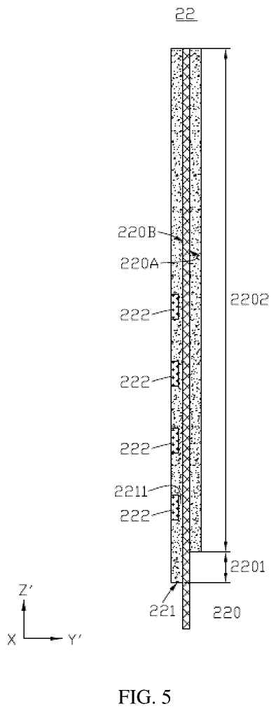

As shown in FIG. 5, in some other embodiments, the second region 2211 may alternatively be located between the negative electrode current collector 220 and the second negative electrode active material layer 222. In this case, it can be understood that after the negative electrode plate 22 shown in FIG. 5 is wound, the second negative electrode active material layer 222 is located on the surface of the second region 2211 facing away from the winding central axis C. During manufacturing of the negative electrode plate 22, the first negative electrode active material layer 221 may be formed on the fourth surface 220B of the negative electrode current collector 220, then multiple mutually spaced second negative electrode active material layers 222 are disposed on the surface of the first negative electrode active material layer 221 facing away from the winding central axis C by gravure coating, and then rolling is performed so that at least a part of the second negative electrode active material is embedded into the first negative electrode active material layer 221, to obtain the negative electrode plate 22. In this case, the first negative electrode active material layer 221 located on the surface of the second negative electrode active material layer 222 facing toward the winding central axis C is the second region 2211. As compared to the technical solution in which the second negative electrode active material layer 222 is disposed on the surface of the second region 2211 facing toward the winding central axis C, this embodiment can increase the capacity per unit area of the negative electrode active material opposite to the first region 2111 under the premise that the negative electrode plate 22 has the same thickness. In addition, after rolling, a part of the second negative electrode active material may protrude from the surface of the first negative electrode active material layer 221, so this part of the second negative electrode active material can increase the space for storing and circulating the electrolyte, facilitating electrolyte infiltration, thereby further reducing the risk of lithium precipitation on the negative electrode plate 22 in the first corner region 202.

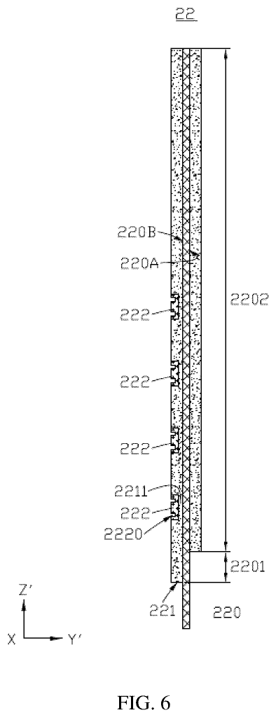

Referring to FIG. 6, in some embodiments, when the second region 2211 is located between the negative electrode current collector 220 and the second negative electrode active material layer 222, at least one groove 2220 may alternatively be provided on the second negative electrode active material layer 222. The groove 2220 may be obtained by removing a part of the second negative electrode active material layer 222 by laser cutting. The provision of the groove 2220 is also conducive to increasing the space for storing and circulating the electrolyte, facilitating electrolyte infiltration, thereby further reducing the risk of lithium precipitation on the negative electrode plate 22 in the first corner region 202.

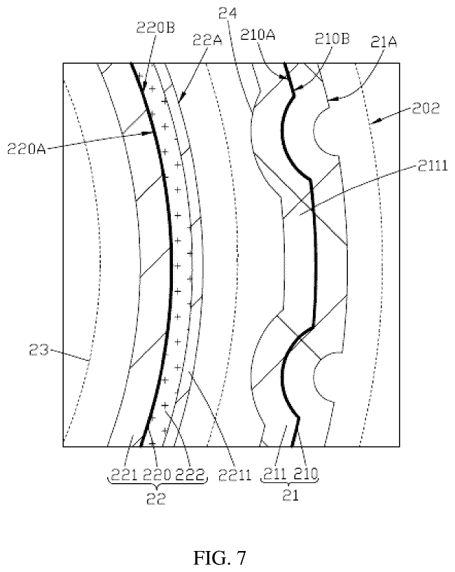

As shown in FIG. 1, in some embodiments, the positive electrode plate 21 includes a first corner segment 21A located in the first corner region 202, where the first corner segment 21A includes the above first region 2111. The negative electrode plate 22 includes a second corner segment 22A located in the first corner region 202, where the second corner segment 22A includes the above second region 2211. The first corner segment 21A is located on an outer side of the second corner segment 22A facing away from the winding central axis C and is disposed opposite to the second corner segment 22A. Referring to FIG. 7, the first corner segment 21A includes multiple protrusions 24. The protrusions 24 are integrally provided on the first corner segment 21A and protrude from the first corner segment 21A in a direction facing toward the winding central axis C or facing away from the winding central axis C. The provision of the protrusions 24 on the first corner segment 21A is conducive to alleviating the risk of deterioration of electrolyte infiltration in the first corner region 202 caused by increased local volume swelling after the provision of the second negative electrode active material layer 222 on the negative electrode plate 22 (for example, provision of a second negative electrode active material layer 222 including a silicon material), enhancing the ability of the first corner region 202 to store electrolyte, thereby further prolonging the cycle life of the secondary battery 100. During manufacturing of the positive electrode plate 21, the positive electrode plate 21 may be embossed by a pressure roller, so that multiple protrusions 24 are formed on the first corner segment 21A of the positive electrode plate 21, and through the embossing process, multiple protrusions 24 may be formed on one side of the first corner segment 21A, while multiple depressions are formed on another side of the first corner segment 21A.

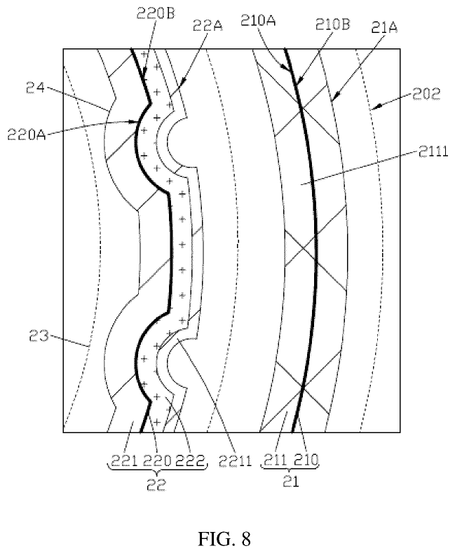

As shown in FIG. 8, in some other embodiments, the second corner segment 22A includes multiple protrusions 24. The protrusions 24 are integrally provided on the second corner segment 22A and protrude from the second corner segment 22A in a direction facing toward the winding central axis C or facing away from the winding central axis C. The provision of the protrusions 24 on the first corner segment 21A is also conducive to alleviating the risk of deterioration of electrolyte infiltration in the first corner region 202 caused by increased local volume swelling after the provision of the second negative electrode active material layer 222 on the negative electrode plate 22 (for example, provision of a second negative electrode active material layer 222 including a silicon material), enhancing the ability of the first corner region 202 to store electrolyte, thereby further prolonging the cycle life of the secondary battery 100.

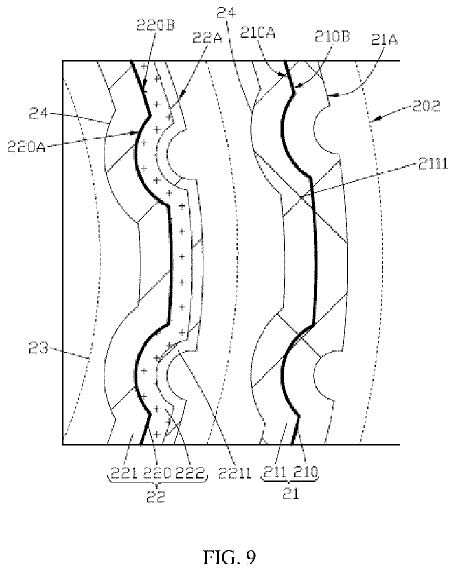

As shown in FIG. 9, in some other embodiments, the first corner segment 21A and the second corner segment 22A are each provided with multiple protrusions 24. In this way, the ability of the first corner region 202 to store electrolyte can be further enhanced, thereby further prolonging the cycle life of the secondary battery 100.

When viewed from the third direction Z, at least one of the multiple protrusions 24 of the first corner segment 21A at least partially overlaps with at least one of the multiple protrusions 24 of the second corner segment 22A. For example, the multiple protrusions 24 of the first corner segment 21A may be configured to overlap with the multiple protrusions 24 of the second corner segment 22A. Further, the mutually overlapping protrusions 24 protrude in the same direction. For example, when the protrusions 24 of the first corner segment 21A protrude in the direction facing toward the winding central axis C, the protrusions 24 of the second corner segment 22A also protrude in the direction facing toward the winding central axis C, so that the protrusions 24 of the second corner segment 22A can be at least partially embedded into depressions formed on the another side of the first corner segment 21A. During manufacturing of the electrode assembly 20, the positive electrode plate 21, the separator 23, and the negative electrode plate 22 may be stacked and then embossed, so that the protrusions 24 of the first corner segment 21A and the protrusions 24 of the second corner segment 22A can fully overlap. This can reduce the risk of misalignment between the positive electrode plate 21 and the negative electrode plate 22 while enhancing the ability of the first corner region 202 to store electrolyte, so that the first region 2111 and the second negative electrode active material layer 222 can fully correspond to each other after winding, achieving the effect of reducing the risk of lithium precipitation in the first corner region 202.

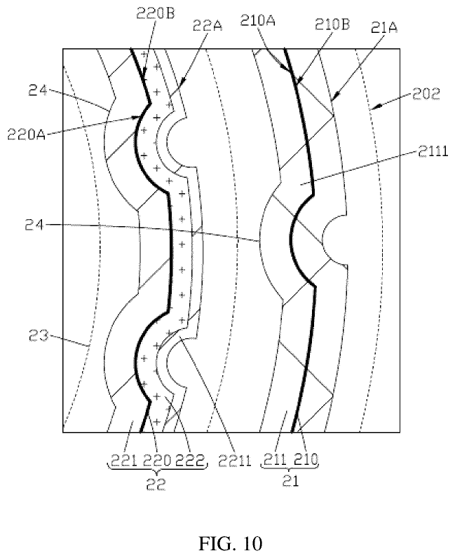

As shown in FIG. 10, the multiple protrusions 24 of the first corner segment 21A may alternatively be configured not to overlap with the multiple protrusions 24 of the second corner segment 22A, which is conducive to further enhancing the ability of the first corner region 202 to store electrolyte, thereby further prolonging the cycle life of the secondary battery 100.

As shown in FIG. 1 and FIG. 4, the negative electrode current collector 220 may include a first conductive region 2201 and a second conductive region 2202 sequentially connected in the winding direction D. The third surface 220A located in the first conductive region 2201 is not provided with the first negative electrode active material layer 221, and the fourth surface 220B located in the first conductive region 2201 is provided with the first negative electrode active material layer 221, that is, the first conductive region 2201 is a single-side coated region. Both the third surface 220A and the fourth surface 220B located in the second conductive region 2202 are provided with the first negative electrode active material layer 221, that is, the second conductive region 2202 is a double-side coated region. In some embodiments, the second negative electrode active material layer 222 is disposed on the second conductive region 2202. Materials on two sides of the single-side coated region are uneven, which results in possible tension in the single-side coated region after winding. Therefore, as compared to the technical solution in which the second negative electrode active material layer 222 is disposed on the first conductive region 2201, disposing the second negative electrode active material layer 222 on the second conductive region 2202 can reduce the risk of the first conductive region 2201 being more prone to wrinkling under tension, further prolonging the cycle life of the secondary battery 100.

Further, the negative electrode plate 22 is defined to have N turns along the winding direction D, where N is a positive integer greater than 3. The second negative electrode active material layer 222 is located from the m-th turn to the n-th turn of the negative electrode plate 22 along the winding direction D, where m is the first turn where the second conductive region 2202 in the negative electrode plate 22 is wound, and N/3≤n≤N/2. The number of the second negative electrode active material layers 222 located from the m-th turn to the n-th turn of the negative electrode plate 22 may be one or more. Since the second negative electrode active material layer 222 is located from the m-th turn to the n-th turn of the negative electrode plate 22, the second negative electrode active material layer 222 is located on the second conductive region 2202 closer to the winding central axis C along the winding direction D. Since a first negative electrode active material layer 221 closer to the winding central axis C in the first corner region 202 has a higher risk of lithium precipitation (for example, a part closer to the winding central axis C in the first corner region 202 may have insufficient electrolyte infiltration, and for another example, the positive and negative electrode plates closer to the winding central axis C in the first corner region 202 have greater difference in capacity per unit area), providing the second negative electrode active material layer 222 from the m-th turn to the n-th turn of the negative electrode plate 22 can alleviate the risk of lithium precipitation in this part of the first negative electrode active material layer 221, further improving the safety and cycle life of the secondary battery 100. In these embodiments of this application, a virtual plane passing through the winding central axis C and perpendicular to the second direction Y is defined as a winding central plane P, the winding central plane P divides the electrode assembly 20 into two parts with substantially the same thickness in the second direction Y, the winding central plane intersects with each turn of the electrode assembly 20 at two intersection points in the first corner region 202 and the second corner region 204, respectively, and each turn of winding means that: an intersection point between the winding central plane P and one corner region, as a starting edge of this turn, extends along the winding direction D to an intersection point, as the ending edge of this turn, between the winding central plane P and the other corner region.

The secondary battery 100 of this application may be a lithium secondary battery, including a lithium metal secondary battery, a lithium-ion secondary battery, a lithium polymer secondary battery, or a lithium-ion polymer secondary battery.

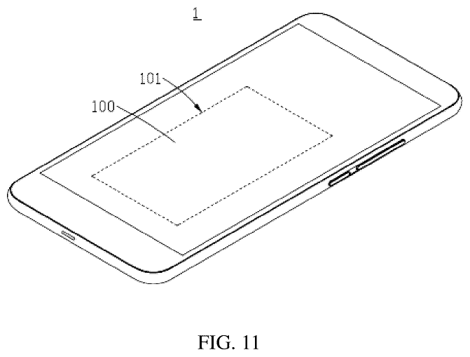

Referring to FIG. 11, an embodiment of this application further provides an electronic apparatus 1, where the electronic apparatus 1 includes a battery compartment 101 and the above secondary battery 100 disposed in the battery compartment 101. The secondary battery 100 of this application is suitable for electronic apparatuses 1 in various fields. The electronic apparatus 1 is supplied with power by the above secondary battery 100, and the lithium precipitation in the first corner region 202 of the electrode assembly 20 is alleviated, so the secondary battery 100 has better safety and cycle life. In one embodiment, the electronic apparatus 1 of this application may be, but is not limited to, a laptop, a pen input computer, a mobile computer, an e-book player, a portable phone, a portable fax machine, a portable copier, a portable printer, a stereo headset, a video recorder, a liquid crystal display television, a portable cleaner, a portable CD player, a mini disc, a transceiver, an electronic notebook, a calculator, a memory card, a portable recorder, a radio, a backup power source, a motor, an automobile, a motorcycle, a power-assisted bicycle, a bicycle, a lighting fixture, a toy, a game console, a clock, a power tool, a flash lamp, a camera, a large household storage battery, and a lithium ion capacitor.

The following provides a detailed description of this application through specific examples and comparative examples. The secondary battery 100 being a lithium-ion secondary battery is used as an example to provide a detailed description of this application with reference to specific preparation processes and test methods. Those skilled in the art should understand that the preparation methods described in this application are only examples, and any other suitable preparation methods are within the scope of this application.

### Example 1

(1) Preparation of positive electrode plate 21: Lithium cobalt oxide (LiCoO₂) as a positive electrode active material, conductive carbon black (Super P), and polyvinylidene fluoride (PVDF) were mixed at a weight ratio of 96.5:1.5:2, N-methylpyrrolidone (NMP) was added as a solvent to prepare a slurry with a solid content of 75 wt %, and the slurry was stirred uniformly. A foamed adhesive was pre-applied to a part of a surface of the positive electrode current collector 210 that is an aluminum foil with a thickness of 9 m; and the slurry was uniformly applied on a first surface 210A of the aluminum foil and heated to cause the foamed adhesive to fall off so that a part of the surface of the aluminum foil was exposed, followed by drying at 90° C. The above application step was repeated on a second surface 210B of the aluminum foil to obtain an initial positive electrode plate having both surfaces coated. The initial positive electrode plate was cold-pressed to obtain an aluminum foil having one side coated with a positive electrode active material layer 211 with a thickness of 77 m, followed by processes such as cutting to obtain a positive electrode plate 21. Then, a positive electrode tab was welded to the exposed aluminum foil, and the positive electrode tab was made of aluminum.
(2) Preparation of negative electrode plate 22: A silicon-carbon compound as a second negative electrode active material, artificial graphite, conductive carbon black, and a polyacrylic acid binder were mixed at a weight ratio of 8:89:1.5:1.5, deionized water was added as a solvent to prepare a slurry with a weight percentage of 55 wt %, and the slurry was stirred uniformly. The slurry was applied in a spaced manner on a fourth surface 220B of the negative electrode current collector 220 that is a copper foil with a thickness of 5 m by gravure coating, followed by drying at 90° C. Subsequently, artificial graphite as a first negative electrode active material, conductive carbon black, and a polyacrylic acid binder (PAA) were mixed at a weight ratio of 97:1.5:1.5, deionized water was added as a solvent to prepare another slurry with a weight percentage of 55 wt %, and the slurry was stirred uniformly. The slurry was uniformly applied on a third surface 220A of the copper foil, followed by drying at 90° C. The above application step was repeated on the fourth surface 220B of the copper foil, and the second negative electrode active material slurry was applied on a part of the first negative electrode active material layer, followed by drying at 90° C. to obtain an initial negative electrode plate having both surfaces coated. Then, the initial negative electrode plate was rolled to obtain one first negative electrode active material layer 221 with a coating thickness of 60 m and one second negative electrode active material layer 222 with a coating thickness of 40 m. Subsequently, a part of the first negative electrode active material layer was laser-etched to expose the copper foil, and a negative electrode tab was welded to the exposed copper foil, where the negative electrode tab was made of nickel.
(3) Preparation of electrolyte: In a dry argon atmosphere, organic solvents ethylene carbonate (EC), ethyl methyl carbonate (EMC), and diethyl carbonate (DEC) were first mixed at a mass ratio of EC:EMC:DEC=30:50:20, and then a lithium salt lithium hexafluorophosphate (LiPF₆) was added to the organic solvents, dissolved, and mixed uniformly, to obtain an electrolyte with a lithium salt concentration of 1.15 mol/L.
(4) Preparation of separator 23: A polyethylene (PE) film with a thickness of 9 m was used.
(5) Preparation of secondary battery 100: The positive electrode plate 21, the separator 23, and the negative electrode plate 22 were sequentially stacked and wound to obtain the electrode assembly 20 shown in FIG. 1, and after winding, the second negative electrode active material layer 222 was located on a surface of the second region 2211 facing toward the winding central axis C. Then, the electrolyte was injected into a recess of an aluminum plastic film, and the positive electrode tab and the negative electrode tab were led out of the aluminum plastic film, followed by packaging to obtain a secondary battery 100.

### Example 2

Example 2 differed from Example 1 in the preparation of the negative electrode plate 22. Specifically, the first negative electrode active material was first applied on a surface of a negative electrode current collector 220, and then the second negative electrode active material was applied in a spaced manner, so that after winding, the second region 2211 was located between the negative electrode current collector 220 and the second negative electrode active material layer 222 (that was, the second negative electrode active material layer 222 was located on the surface of the second region 2211 facing away from the winding central axis C).

### Comparative Example 1

Comparative Example 1 differed from Example 1 in that the second negative electrode active material layer was omitted in the negative electrode plate.

### Comparative Example 2

Comparative Example 2 differed from Example 1 in that the first negative electrode active material and the second negative electrode active material were alternately applied on a fourth surface of the negative electrode current collector, and after winding, the second negative electrode active material was located in a first corner region, that was, only the second negative electrode active material was present in the first corner region.

Then, lithium precipitation tests and cycling capacity retention rate tests were performed on the secondary batteries of the examples and comparative examples, respectively. The test results were recorded in Table 1.

Cycling interface test steps were as follows: (1) At a test temperature of 25° C., the secondary battery 100 was left standing for 30 min and stepwise charged according to the following charging steps: (a) charged to 4.23 V at a constant current of 2.0 C, and charged at a constant voltage to 1.8 C; (b) charged to 4.3 V at a constant current of 1.8 C, and charged at a constant voltage to 1.4 C; (c) charged to 4.4 V at a constant current of 1.4 C, and charged at a constant voltage to 1.0 C; and (d) charged to 4.5 V at a constant current of 1.0 C, charged at a constant voltage to 0.05 C, left standing for 10 min, and then discharged according to the following steps: discharged to 3 V at a direct current of 1 C. The above charging and discharging process was one cycle, and 1000 cycles were repeated. (2) An electrode assembly 20 was disassembled; a surface of the negative electrode plate 22 in the first corner region 202 was checked; if there was a gray region, there was lithium precipitation; if there was no gray region, there was no lithium precipitation. The degree of lithium precipitation was divided into slight lithium precipitation, moderate lithium precipitation, and severe lithium precipitation. Slight lithium precipitation means that the lithium precipitation region is less than 0.5% of the overall region of the negative electrode plate 22, moderate lithium precipitation means that the lithium precipitation region is 0.5% to 5% of the overall region of the negative electrode plate 22, and severe lithium precipitation means that the lithium precipitation region is greater than 5% of the overall region of the negative electrode plate 22.

Cycling capacity retention rate test steps were as follows: (1) Charging and discharging cycles were performed according to the above steps, and a discharge capacity of the first cycle and a discharge capacity of the 1000th cycle were recorded. (2) Calculation was performed according to the formula: Cycling capacity retention rate=(discharge capacity of secondary battery after 1000 cycles/discharge capacity of first cycle)×100%.

TABLE 1

| | Active | Active | | | |
|---|---|---|---|---|---|
| | material | material of | Position of | | |
| | of first | second | second | | |
| | negative | negative | negative | | |
| | electrode | electrode | electrode | | Cycling |
| | active | active | active | | capacity |
| | material | material | material | Interface | retention |
| | layer | layer | layer | condition | rate (%) |
| Example 1 | Graphite | Silicon- | Surface of | No lithium | 88.5% |
| | | carbon | second | precipitation | |
| | | compound + | region | | |
| | | artificial | facing | | |
| | | graphite | toward | | |
| | | | winding | | |
| | | | central axis | | |
| Example 2 | Graphite | Silicon- | Surface of | Slight lithium | 87.1% |
| | | carbon | second | precipitation | |
| | | compound + | region | | |
| | | artificial | facing away | | |
| | | graphite | from | | |
| | | | winding | | |
| | | | central axis | | |
| Comparative | Graphite | / | / | Severe lithium | 83% |
| Example 1 | | | | precipitation | |
| Comparative | Graphite | Silicon- | Surface of | Moderate | 84.1% |
| Example 2 | | carbon | negative | lithium | |
| | | compound + | electrode | precipitation | |
| | | artificial | current | | |
| | | graphite | collector | | |

From the data in Table 1, it can be seen that as compared to Comparative Examples 1 and 2, in Examples 1 and 2, the risk of lithium precipitation on the negative electrode plate in the first corner region is alleviated, and the cycling capacity retention rate of the secondary battery is increased by providing a silicon material as the second negative electrode active material on the second region. As compared to Example 2, in Example 1, the second region is provided on the surface of the first region facing toward the winding central axis, that is, the second region is located between the first region and the negative electrode current collector, so during lithium ion deintercalation, lithium ions are preferentially intercalated into the first negative electrode active material layer, the lithium intercalation degree of the second negative electrode active material layer is lower, the swelling rate is smaller, and the second negative electrode active material has less destruction and pulverization during a long cycling process, which is conducive to extending the cycle life of the second negative electrode active material. In addition, the first negative electrode active material layer located on the upper layer can, to some extent, suppress the swelling of the second negative electrode active material layer, reducing the risk of electrolyte shortage due to small spacing between electrode plates in the first corner region, which is conducive to increasing the space for storing and circulating the electrolyte and facilitating electrolyte infiltration. Therefore, the risk of lithium precipitation on the negative electrode plate in the first corner region in Example 1 is further reduced, and the cycling capacity retention rate of the secondary battery is higher.

### Examples 3 to 16

Examples 3 to 16 differed from Example 1 in the ratio of the gram capacity of the second negative electrode active material layer 222 to the gram capacity of the first negative electrode active material layer 221, or the coating weight per unit area of the second negative electrode active material layer, and the number of turns n of the second negative electrode active material layer along the winding direction on the negative electrode plate. Details were recorded in Table 2.

The ratio of the gram capacity of the second negative electrode active material layer to the gram capacity of the first negative electrode active material layer 221 was adjusted by adjusting the gram capacity of the second negative electrode active material layer 222. In addition to the silicon-carbon compound, the second negative electrode active material could also include graphite, and the gram capacity of the second negative electrode active material layer 222 was adjusted by adjusting the ratio of the silicon-carbon compound to the graphite in the second negative electrode active material. The compositions of the second negative electrode active materials in Examples 3 to 16 were respectively as follows.

Example 3: The weight ratio of silicon-carbon compound, artificial graphite, conductive carbon black, and polyacrylic acid binder was 3:94:1.5:1.5.

Example 4: The weight ratio of silicon-carbon compound, artificial graphite, conductive carbon black, and polyacrylic acid binder was 3.57:93.43:1.5:1.5.

Example 5: The weight ratio of silicon-carbon compound, artificial graphite, conductive carbon black, and polyacrylic acid binder was 10.74:86.26:1.5:1.5.

Example 6: The weight ratio of silicon-carbon compound, artificial graphite, conductive carbon black, and polyacrylic acid binder was 15.03:81.97:1.5:1.5.

Example 7: The weight ratio of silicon-carbon compound, artificial graphite, conductive carbon black, and polyacrylic acid binder was 17:80:1.5:1.5.

Examples 8 to 16: The weight ratios of the components in the second negative electrode active material were the same as in Example 1.

Then, lithium precipitation tests and cycling capacity retention rate tests were performed on the secondary batteries of the examples and comparative examples, respectively. The test results were recorded in Table 2.

The gram capacity of the first negative electrode active material layer 221 could be measured by the following method: (1) At a test temperature of 25° C., the secondary battery 100 was discharged to 0 SOC % and disassembled to obtain the negative electrode plate 22, a single-side coated negative electrode plate 22 with a certain area was punched from the negative electrode plate 22 in the first flat region 201 as a sample and weighed with a balance, the weight was recorded as W₁, then a negative electrode current collector 220 with the same area was punched and weighed with the balance, and the weight was recorded as W₂. (2) The above sample and a lithium sheet were assembled into a button battery, the button battery was left standing for 4 hours, discharged at a constant current of 20 μA to 0.005 V, left standing for 5 minutes, and then charged at a constant current of 20 μA to 2.0 V, and a capacity Q₁ of the button battery was measured. (3) Calculation was performed according to the formula: Gram capacity of first negative electrode active material layer 221=Q₁/(W₁−W₂).

The gram capacity of the second negative electrode active material layer 222 could be measured by the following method: (1) At a test temperature of 25° C., the secondary battery 100 was discharged to 0 SOC % and disassembled to obtain the negative electrode plate 22, a negative electrode plate 22 with a certain area was punched from the negative electrode plate 22 in the first corner region 202 as a sample, a cross section of the sample was observed under a microscope, and an obvious boundary between the second negative electrode active material layer 222 close to the negative electrode current collector 220 and the first negative electrode active material layer 221 far from the negative electrode current collector 220 could be observed, the entire first negative electrode active material layer 221 on the upper layer and a part of the second negative electrode active material layer 222 on the lower layer were scraped off with a scraper (ensuring that the scraped parts exceeded the boundary between the first negative electrode active material layer 221 and the second negative electrode active material layer 222 observed under the microscope), and then the second negative electrode active material layer 222 on the lower layer was still scraped off and collected, the collected second negative electrode active material layer 222 was weighed with a balance, and the weight was recorded as W₃. (2) The above sample and a lithium sheet were assembled into a button battery, the button battery was left standing for 4 hours, discharged at a constant current of 20 μA to 0.005 V, left standing for 5 minutes, and then charged at a constant current of 20 μA to 2.0 V, and a capacity Q₂ of the button battery was measured. (3) Calculation was performed according to the formula: Gram capacity of second negative electrode active material layer 222=Q₂/W₃; and then the ratio of the gram capacity of the second negative electrode active material layer 222 to the gram capacity of the first negative electrode active material layer 221 was calculated.

The coating weight per unit area of the second negative electrode active material layer 222 could be measured by the following method: (1) At a test temperature of 25° C., the secondary battery 100 was discharged to 0 SOC % and disassembled to obtain the negative electrode plate 22, and the negative electrode plate 22 was cleaned with dimethyl carbonate (DMC) and then dried. (2) A single-side coated negative electrode plate 22 with an area of S₁ was punched from the negative electrode plate 22 in the first flat region 201 as a first negative electrode active material layer sample, and a mass of the sample was weighed as W₄, a cross section of the sample was observed under a scanning electron microscope to obtain a thickness d₁ of the first negative electrode active material layer, a negative electrode current collector 220 with an area of S₁ was cut and weighed with a balance to obtain its mass W₅, and a density ρ₁ of the first negative electrode active material was calculated according to the formula ρ₁=(W₄−W₅)/(S₁×d₁). (3) A negative electrode plate 22 with an area of S₂ was punched from the negative electrode plate 22 in the first corner region 202 as a first corner region sample, the sample was weighed with a balance to obtain a weight recorded as Wₜₒₜₐₗ, a cross section of the first corner region sample was observed under a scanning electron microscope to obtain a thickness d₂ of the first negative electrode active material layer 221, the first negative electrode active material layer 221 and the second negative electrode active material layer 222 of the sample were washed off with a solvent N-methylpyrrolidone (NMP) and dried, a weight of the negative electrode current collector 220 was weighed and recorded as W₀, and a coating weight per unit area of the second negative electrode active material was calculated according to the following formula: W=[(Wₜₒₜₐₗ−W₀)−ρ₁×S₂×d₂]/S₂.

TABLE 2

| | Gram | | | | | | |
|---|---|---|---|---|---|---|---|
| | capacity | Gram | | | | | |
| | of | capacity | | | | | |
| | second | of first | | | | | |
| | negative | negative | | | | | |
| | electrode | electrode | | Coating | | | |
| | active | active | | weight | | | Cycling |
| | material | material | Ratio of | per unit | | | capacity |
| | layer | layer | gram | area | | Interface | retention |
| | (mA · h/g) | (mA · h/g) | capacities | (mg/cm²) | n | condition | rate (%) |
| Example 1 | 445 | 356 | 1.25 | 2.0 | N/3 | No lithium | 88.5% |
| | | | | | | precipitation | |
| Example 3 | 384.5 | 356 | 1.08 | 2.0 | N/3 | Moderate | 85.3% |
| | | | | | | lithium | |
| | | | | | | precipitation | |
| Example 4 | 391.6 | 356 | 1.1 | 2.0 | N/3 | Moderate | 86.8% |
| | | | | | | lithium | |
| | | | | | | precipitation | |
| Example 5 | 480.6 | 356 | 1.35 | 2.0 | N/3 | No lithium | 88.9% |
| | | | | | | precipitation | |
| Example 6 | 534 | 356 | 1.5 | 2.0 | N/3 | Slight | 87.8% |
| | | | | | | lithium | |
| | | | | | | precipitation | |
| Example 7 | 558.4 | 356 | 1.57 | 2.0 | N/3 | Moderate | 85.9% |
| | | | | | | lithium | |
| | | | | | | precipitation | |
| Example 8 | 445 | 356 | 1.25 | 0.9 | N/3 | Moderate | 85.2% |
| | | | | | | lithium | |
| | | | | | | precipitation | |
| Example 9 | 445 | 356 | 1.25 | 1.0 | N/3 | Moderate | 86.6% |
| | | | | | | lithium | |
| | | | | | | precipitation | |
| Example 10 | 445 | 356 | 1.25 | 1.5 | N/3 | Slight | 87.1% |
| | | | | | | lithium | |
| | | | | | | precipitation | |
| Example 11 | 445 | 356 | 1.25 | 2.5 | N/3 | No lithium | 89.1% |
| | | | | | | precipitation | |
| Example 12 | 445 | 356 | 1.25 | 3.0 | N/3 | Slight | 87.7% |
| | | | | | | lithium | |
| | | | | | | precipitation | |
| Example 13 | 445 | 356 | 1.25 | 3.1 | N/3 | Moderate | 85.6% |
| | | | | | | lithium | |
| | | | | | | precipitation | |
| Example 14 | 445 | 356 | 1.25 | 2.0 | N/4 | Moderate | 86.1% |
| | | | | | | lithium | |
| | | | | | | precipitation | |
| Example 15 | 445 | 356 | 1.25 | 2.0 | N/2 | No lithium | 89.0% |
| | | | | | | precipitation | |
| Example 16 | 445 | 356 | 1.25 | 2.0 | 2N/3 | Moderate | 85.5% |
| | | | | | | lithium | |
| | | | | | | precipitation | |

From the data of Examples 1 and 3 to 7 in Table 2, it can be seen that when the ratio of the gram capacity of the second negative electrode active material layer to the gram capacity of the first negative electrode active material layer is less than 1.1, the improvement in the interface condition and cycling capacity retention rate of the first corner region is not significant; when the ratio of the gram capacity of the second negative electrode active material layer to the gram capacity of the first negative electrode active material layer is less than or equal to 1.35, as the ratio of gram capacities increases, the interface condition of the first corner region is gradually improved, and the cycling capacity retention rate is gradually increased, this is because as the gram capacity of the second negative electrode active material layer increases, the number of lithium ions that can be received in the first corner region increases, so that the lithium precipitation condition in the first corner region is improved, and the cycling capacity retention rate is increased; and when the ratio of the gram capacity of the second negative electrode active material layer to the gram capacity of the first negative electrode active material layer is greater than or equal to 1.5, the interface condition of the first corner region deteriorates instead, and the cycling capacity retention rate is gradually decreased, this is because when the gram capacity of the second negative electrode active material layer is too large, its swelling rate is increased accordingly, which easily leads to reduced spacing between the electrode plates in the first corner region, the electrolyte is easily squeezed out, the difficulty in electrolyte infiltration is increased, the risk of lithium precipitation in the first corner region due to lack of the electrolyte is increased, and thus a decrease in cycling capacity retention rate is caused. Therefore, the ratio of the gram capacity of the second negative electrode active material layer to the gram capacity of the first negative electrode active material layer is selected to be 1.1 to 1.5. Further, the ratio of the gram capacities is preferably 1.25 to 1.35.

From the experimental data of Examples 1 and 8 to 13, it can be seen that when the coating weight per unit area of the second negative electrode active material layer is less than 1.0 mg/cm², the improvement in the interface condition and cycling capacity retention rate of the first corner region is not significant; when the coating weight per unit area of the second negative electrode active material layer is less than or equal to 2.5 mg/cm², as the coating weight per unit area increases, the interface condition of the first corner region is gradually improved, and the cycling capacity retention rate is gradually increased, this is because as the coating weight per unit area of the second negative electrode active material layer increases, the number of lithium ions that can be received in the first corner region increases, so that the lithium precipitation condition in the first corner region is improved, and the cycling capacity retention rate is increased; and when the coating weight per unit area of the second negative electrode active material layer is greater than or equal to 3.0 mg/cm², the interface condition of the first corner region deteriorates instead, and the cycling capacity retention rate is gradually decreased, this is because when the coating weight per unit area of the second negative electrode active material layer is too large, the thickness of the second negative electrode active material layer increases accordingly, which not only leads to loss of volume energy density of the secondary battery, but also easily leads to reduced spacing between electrode plates in the first corner region, thus the electrolyte is easily squeezed out and the difficulty in electrolyte infiltration is increased, the risk of lithium precipitation in the first corner region due to lack of the electrolyte is increased, and thus a decrease in cycling capacity retention rate is caused. Therefore, the coating weight per unit area of the second negative electrode active material layer is selected to be 1.0 mg/cm² to 3.0 mg/cm². Further, the coating weight per unit area of the second negative electrode active material layer is preferably 1.5 mg/cm² to 3.0 mg/cm². Further, the coating weight per unit area of the second negative electrode active material layer is preferably 2.0 mg/cm² to 2.5 mg/cm².

From the experimental data of Examples 1 and 14 to 16, it can be seen that when n<N/3, the improvement in the interface condition and cycling capacity retention rate of the first corner region is not significant; and when n>N/2, the interface condition of the first corner region also deteriorates, and the cycling capacity retention rate decreases, this is because when the number of winding turns of the second negative electrode active material layer is too large, the electrode plates located in the outer winding turns squeeze the electrode plate located in the inner winding turns, leading to reduced spacing between the electrode plates in the inner winding turns, the electrolyte is easily squeezed out and the difficulty in electrolyte infiltration is increased, so that the risk of lithium precipitation in the first corner region due to lack of the electrolyte is increased, and thus a decrease in cycling capacity retention rate is caused. Therefore,

$$N / 3 \leq n \leq N / 2.$$

In conclusion, it should be noted that the above embodiments are only used to illustrate the technical solutions of this application and are not intended to limit this application. Although this application has been described in detail with reference to preferred embodiments, those of ordinary skill in the art should understand that modifications or equivalent replacements can be made to the technical solutions of this application without departing from the spirit and scope of the technical solutions of this application.

What is claimed is:

1. A secondary battery, comprising an electrode assembly; wherein the electrode assembly comprises a positive electrode plate, a separator, and a negative electrode plate; and the positive electrode plate, the separator, and the negative electrode plate are sequentially stacked and wound; wherein,
the positive electrode plate comprises a positive electrode current collector and a positive electrode active material layer; the positive electrode current collector comprises a first surface facing toward a winding central axis and a second surface facing away from the first surface; the positive electrode active material layer is disposed on both the first surface and the second surface; the negative electrode plate comprises a negative electrode current collector and a first negative electrode active material layer; the negative electrode current collector comprises a third surface facing toward the winding central axis and a fourth surface facing away from the third surface; and the first negative electrode active material layer is disposed on both the third surface and the fourth surface;
the electrode assembly comprises a corner region; the positive electrode active material layer comprises a first region; the first region is disposed on the first surface and located in the corner region; the first negative electrode active material layer comprises a second region; the second region is disposed on the fourth surface and located in the corner region; and the first region is located on an outer side of the second region facing away from the winding central axis and is disposed opposite to the second region; and
the negative electrode plate further comprises a second negative electrode active material layer disposed on the second region; and a gram capacity of the second negative electrode active material layer is greater than a gram capacity of the first negative electrode active material layer.

2. The secondary battery according to claim 1, wherein the electrode assembly further comprises a flat region; along a winding direction of the electrode assembly, the corner region is connected to the flat region; and a length of an overlapping region of the second negative electrode active material layer and the flat region is in a range of 0 mm to 3 mm.

3. The secondary battery according to claim 2, wherein the second negative electrode active material layer is disposed in only the second region.

4. The secondary battery according to claim 1, wherein the second negative electrode active material layer is located on a surface of the second region facing away from the winding central axis.

5. The secondary battery according to claim 1, wherein a surface of the second negative electrode active material layer facing away from the second region is provided with a groove.

6. The secondary battery according to claim 1, wherein the second negative electrode active material layer is located on a surface of the second region facing toward the winding central axis.

7. The secondary battery according to claim 1, wherein a ratio of the gram capacity of the second negative electrode active material layer to the gram capacity of the first negative electrode active material layer is in a range of 1.1 to 1.5.

8. The secondary battery according to claim 7, wherein the ratio of the gram capacity of the second negative electrode active material layer to the gram capacity of the first negative electrode active material layer is in a range of 1.25 to 1.35.

9. The secondary battery according to claim 1, wherein the first negative electrode active material layer comprises a first negative electrode active material; the second negative electrode active material layer comprises a second negative electrode active material; the first negative electrode active material comprises graphite; and the second negative electrode active material comprises a silicon material.

10. The secondary battery according to claim 9, wherein the silicon material comprises one or more selected from the group consisting of silicon oxide, silicon-carbon compound, silicon alloy, and elemental silicon.

11. The secondary battery according to claim 9, wherein the second negative electrode active material further comprises graphite.

12. The secondary battery according to claim 1, wherein a coating weight per unit area of the second negative electrode active material layer is in a range of 1.0 mg/cm² to 3.0 mg/cm².

13. The secondary battery according to claim 12, wherein the coating weight per unit area of the second negative electrode active material layer is in a range of 1.5 mg/cm² to 3.0 mg/cm².

14. The secondary battery according to claim 13, wherein the coating weight per unit area of the second negative electrode active material layer is in a range of 2.0 mg/cm² to 2.5 mg/cm².

15. The secondary battery according to claim 1, wherein the positive electrode plate comprises a first corner segment located in the corner region; the first corner segment comprises the first region; the negative electrode plate comprises a second corner segment located in the corner region; the second corner segment comprises the second region; the first corner segment is located on an outer side of the second corner segment facing away from the winding central axis and is disposed opposite to the second corner segment; and at least one of the first corner segment or the second corner segment comprises multiple protrusions.

16. The secondary battery according to claim 15, wherein the first corner segment and the second corner segment are each provided with the multiple protrusions.

17. The secondary battery according to claim 16, wherein an extension direction of the winding central axis is a first direction; a thickness direction of the electrode assembly is a second direction; and when viewed from a third direction, at least one of the multiple protrusions of the first corner segment at least partially overlaps with at least one of the multiple protrusions of the second corner segment; and/or,
the multiple protrusions of the first corner segment do not overlap with the multiple protrusions of the second corner segment;
wherein the first direction, the second direction, and the third direction are perpendicular to each other.

18. The secondary battery according to claim 1, wherein the negative electrode current collector comprises a first conductive region and a second conductive region sequentially connected in a winding direction; the third surface located in the first conductive region is not provided with the first negative electrode active material layer; the fourth surface located in the first conductive region is provided with the first negative electrode active material layer; both the third surface and the fourth surface located in the second conductive region are provided with the first negative electrode active material layer; and the second negative electrode active material layer is disposed on the second conductive region.

19. The secondary battery according to claim 18, wherein the negative electrode plate has N turns along a winding direction; N is a positive integer greater than 3; the second negative electrode active material layer is located from the m-th turn to the n-th turn of the negative electrode plate along the winding direction; m is the first turn wherein the second conductive region in the negative electrode plate is wound; and N/3≤n≤N/2.

20. An electronic apparatus, wherein the electronic apparatus comprises a secondary battery; the secondary battery comprises an electrode assembly; the electrode assembly comprises a positive electrode plate, a separator, and a negative electrode plate; and the positive electrode plate, the separator, and the negative electrode plate are sequentially stacked and wound; wherein,
the positive electrode plate comprises a positive electrode current collector and a positive electrode active material layer; the positive electrode current collector comprises a first surface facing toward a winding central axis and a second surface facing away from the first surface; the positive electrode active material layer is disposed on both the first surface and the second surface; the negative electrode plate comprises a negative electrode current collector and a first negative electrode active material layer; the negative electrode current collector comprises a third surface facing toward the winding central axis and a fourth surface facing away from the third surface; and the first negative electrode active material layer is disposed on both the third surface and the fourth surface;
the electrode assembly comprises a corner region; the positive electrode active material layer comprises a first region; the first region is disposed on the first surface and located in the corner region; the first negative electrode active material layer comprises a second region; the second region is disposed on the fourth surface and located in the corner region; and the first region is located on an outer side of the second region facing away from the winding central axis and is disposed opposite to the second region; and
the negative electrode plate further comprises a second negative electrode active material layer disposed on the second region; and a gram capacity of the second negative electrode active material layer is greater than a gram capacity of the first negative electrode active material layer.
